(19) United States
(12) Patent Application Publication
(10) Pub. No.: US 2024/0001223 A1
(43) Pub. Date: Jan. 4, 2024

(54) VIRTUAL REALITY/AUGMENTED REALITY SYSTEMS CONFIGURABLE WITH MULTIPLE TYPES OF CONTROLLERS

(71) Applicant: Sony Interactive Entertainment Inc., Tokyo (JP)

(72) Inventors: Hee Gyung Sun, San Francisco, CA (US); Benjamin Andrew Rottler, San Francisco, CA (US)

(21) Appl. No.: 17/856,715

(22) Filed: Jul. 1, 2022

(51) Int. Cl. A63F 13/23; A63F 13/31; A63F 13/533

(52) U.S. Cl. CPC A63F 13/23; A63F 2300/8082; A63F 13/533; A63F 13/31

(57) ABSTRACT

Managing controller connection, including: determining whether at least one controller is connected to a game system, and performing and repeating the following until transitioned into a one-handed operation or two-handed operation of a user: (a) if more than one controller connection is detected, transitioning into the two-handed operation; (b) if no controller connection is detected, requesting the user to connect the at least one controller; (c) if connection of only a first controller is detected, requesting the user to connect a second controller; (d) if connection of the second controller is not detected, transitioning into the one-handed operation, wherein the transition into the one-handed operation is made after determining and deciding to continue with only the first controller.

### BACKGROUND

### Field

The present disclosure relates to managing controller connections, and more specifically, to playing or experiencing interactive games or other application programs that can accept multiple types of controllers and adapt to the situation or environment presented within the game or application program.

### Background

Conventional controllers used for playing interactive games have been focused on a controller or set of controllers that has keys or buttons preset or predetermined. In particular, the controllers that are used to play or experience virtual reality (VR) and/or augmented reality (AR) interactive games or other application programs may be limited.

### SUMMARY

The present disclosure provides for managing controller connection while a user plays or experiences interactive games or application programs that can accept multiple types of controllers and adapt to the situation or environment presented within the game or non-game applications.

In one implementation, a method for managing controller connection includes determining whether at least one controller is connected to a game system, and performing and repeating a series of steps until the user is transitioned into a one-handed operation or two-handed operation. The steps of the method includes: (a) if more than one controller connection is detected, transitioning into the two-handed operation; (b) if no controller connection is detected, requesting the user to connect the at least one controller; (c) if connection of only a first controller is detected, requesting the user to connect a second controller; (d) if connection of the second controller is not detected, transitioning into the one-handed operation after determining and deciding to continue with only the first controller.

In another implementation, a system for managing controller connection includes a connection determiner, a user interface, and a processor. The connection determiner determines whether at least one controller is connected to a game system. The user interface enables a user to input and receive commands and requests. The processor performs and repeats a series of steps until the user is transitioned into a one-handed operation or two-handed operation. The steps of the method includes: (a) if more than one controller connection is detected, transitioning into the two-handed operation; (b) if no controller connection is detected, requesting the user to connect the at least one controller; (c) if connection of only a first controller is detected, requesting the user to connect a second controller; (d) if connection of the second controller is not detected, transitioning into the one-handed operation after determining and deciding to continue with only the first controller.

In yet another implementation, a non-transitory computer-readable storage medium storing a computer program to manage controller connection includes a computer program including executable instructions that cause a computer to determine whether at least one controller is connected to a game system, and perform and repeat a series of steps until the user is transitioned into a one-handed operation or two-handed operation. The steps of the computer program includes: (a) if more than one controller connection is detected, transitioning into the two-handed operation; (b) if no controller connection is detected, requesting the user to connect the at least one controller; (c) if connection of only a first controller is detected, requesting the user to connect a second controller; (d) if connection of the second controller is not detected, transitioning into the one-handed operation after determining and deciding to continue with only the first controller.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIGS. 1A and 1B are example illustrations of a single controller and a paired controller, respectively, configured to enable a user to input, control, or interact with characters or elements within the game or non-game applications;

FIG. 2A is a flow diagram of a process for managing controller connection in accordance with one implementation of the present disclosure;

FIG. 2B is a flow diagram of a process 250 for managing controller connection in accordance with another implementation of the present disclosure;

FIG. 3 is a block diagram of a controller management system for managing controller connection in accordance with one implementation of the present disclosure;

FIG. 4 is a list of user icons who are playing or experiencing interactive games or other application programs in accordance with one implementation of the present disclosure;

FIG. 5 is a screen shot of a gestural operation performed by a user in an interactive game in accordance with one implementation of the present disclosure;

FIG. 6 is a screen shot of another gestural operation performed by a user in an interactive game in accordance with another implementation of the present disclosure;

FIG. 7A is a representation of a computer system and a user in accordance with an implementation of the present disclosure; and

FIG. 7B is a functional block diagram illustrating the computer system hosting a controller management application in accordance with an implementation of the present disclosure.

### DETAILED DESCRIPTION

As described above, conventional controllers used for playing interactive games have been focused on a controller or set of controllers that has keys or buttons preset or predetermined. In particular, the controllers that are used to play or experience virtual reality (VR) and/or augmented reality (AR) interactive games or other application programs may be limited.

Certain implementations of the present disclosure provide methods and systems for playing or experiencing interactive games or other application programs (e.g., interactive experiences or non-game applications including messaging applications) that can accept multiple types of controllers and adapt to the situation or environment presented within the game or non-game applications. Some implementations of the present disclosure also provide methods and systems for managing controller connections and updating controller information of other users. In one implementation, the controller is a first type of gaming controller which is generally designed to be grasped and operated with both hands (hereinafter referred to as a “single controller”). In another implementation, the controller is a second type of gaming controller including a pair of controllers which are generally designed to be grasped and operated with both hands (hereinafter referred to as a “paired controller”). Thus, the paired controller can be used for sensing hand and finger movements for both hands or each hand separately. In a further implementation, the controller operations include gesture operations such as clipping virtual images for various purposes including sharing the images through social media platforms.

After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

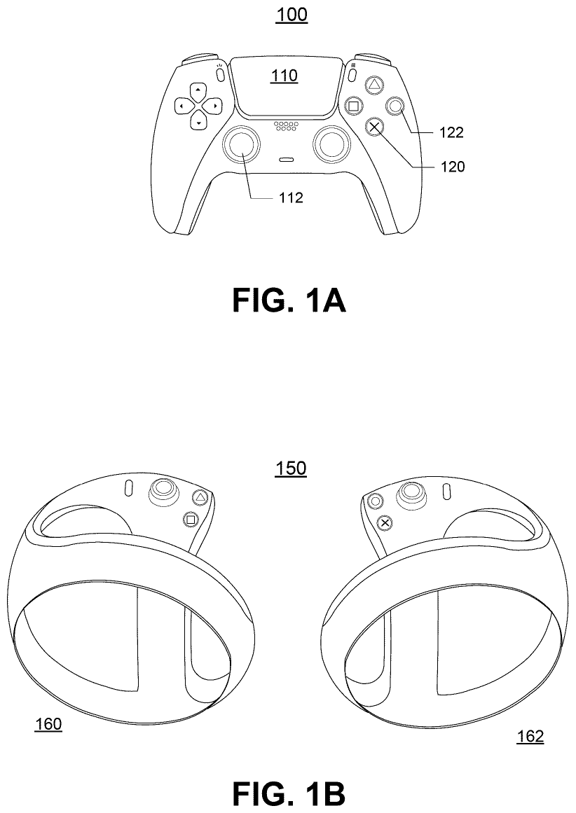

FIGS. 1A and 1B are example illustrations of a single controller 100 and a paired controller 150, respectively, configured to enable a user to input, control, or interact with characters or elements within the game or non-game applications. In the illustrated implementations of FIGS. 1A and 1B, the controllers 100, 150 are used as VR/AR controllers.

In FIG. 1A, the single controller 100 is configured with the core navigation, the button mapping, and the user interface (UI) structure that are same as those of the television controller interface. Thus, the same input model applies, and no additional adjustments are needed to support the VR experience. Therefore, the focus movement, for example, is controlled with D-pad 110 and left analog stick 112, while the selection, for example, is controlled with cross 120 and circle 122.

In FIG. 1B, the paired controller 150 is configured with the core navigation, the button mapping, and the user interface (UI) structure that are same as those of the television controller interface, but with the buttons separated into two controllers. Therefore, the focus movement, for example, is controlled with the left controller 160, while the forward and back navigations, for example, are controlled with right controller 162.

In one implementation, the paired controller 150 is configured for one-handed operation to use either the left controller 160 or the right controller 162. In one example, the one-handed operation may be entered at the beginning when only one controller is connected. In this example, the button assignments may switch to the preset assignments with or without a confirmation dialog. In another example, the one-handed operation may be entered in the middle (e.g., of playing a game) when the power on one of the controllers goes out. In this example, the button assignments may switch to the preset assignments with or without a confirmation dialog. In yet another example, the one-handed operation may be entered at the beginning or middle when the user requests to use only one controller. In this example, the button assignments may switch to the preset assignments without a confirmation dialog. In one implementation, the paired controller 150 is transitioned to the one-handed operation by modifying the button mappings with minimal changes to enable the user to move focus, select, and go back without having conflicting mapping compared to the single controller 100.

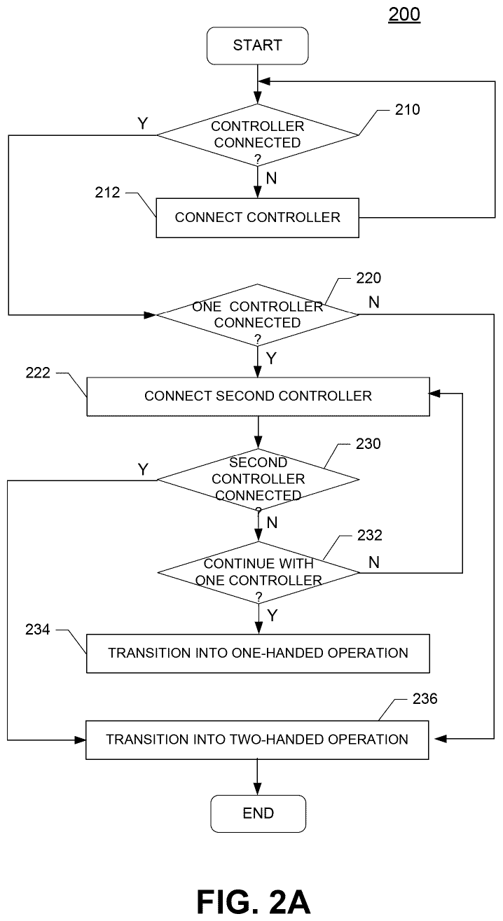

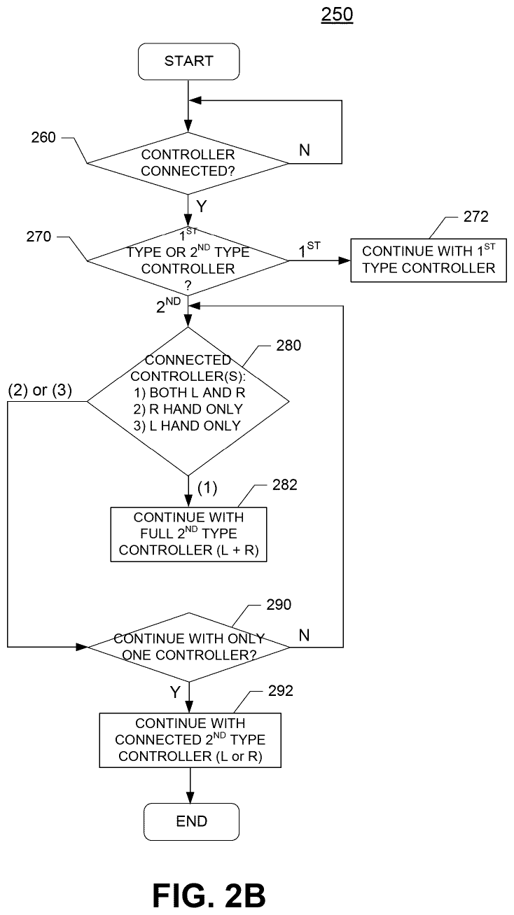

FIG. 2A is a flow diagram of a process 200 for managing controller connection in accordance with one implementation of the present disclosure. In one implementation, the process 200 manages connections of controller configurations including at least one of: a single controller; a paired controller having a pair of left and right controllers; a paired controller including a left controller only; and a paired controller including a right controller only. In one implementation, the process 200 is programmed into a hardware processor to manage the controller connections within a controller management system.

In the illustrated implementation of FIG. 2A, a status check is made, at step 210, to determine whether at least one controller is connected. If no controller connection is detected, at step 210, the user is requested to connect the controller, at step 212, and the process moves back to step 210. Otherwise, if at least one controller connection is detected, at step 210, a status check is made, at step 220, to determine whether one controller is connected. The one connected controller may be either a right or left controller.

If more than one controller connection is detected, at step 220, the process transitions into a two-handed operation, at step 280. Otherwise, if only one controller connection is detected, at step 220, the user is requested to connect the second controller, at step 222. Further, a status check is made, at step 230, to determine whether the second controller has been connected, and the process transitions into a two-handed operation, at step 280, if the second controller connection has been detected, at step 230. Otherwise, if the second controller connection is not detected, at step 230, a determination is made, at step 232, whether the process should continue with only one controller.

If it is determined, at step 232, that the process should continue with only one controller, the process transitions into a one-handed operation, at step 234. Otherwise, if it is determined, at step 232, that the process should not continue with only one controller, the process moves back to requesting the user to connect the second controller, at step 222. In one implementation, the determination (at step 232) is made by inquiring the user. In another implementation, the determination (at step 232) is made by the processor with information about a game system. Thus, if the game system does not allow the one-handed operation, the process 200 will continue to request the user, at step 222, to connect the second controller until the connection of the second controller is detected, at step 230. Once the second controller is detected, at step 230, the process 200 transitions into the two-handed operation, at step 236.

In one implementation, the game system includes a gaming console providing interactive games or application programs. In another implementation, the game system includes an online interactive game or non-game applications. In yet another implementation, the game system includes a virtual reality and/or augmented reality interactive game or non-game applications.

In a particular implementation, a method for managing controller connection is disclosed. The method includes: determining whether at least one controller is connected to a game system, and performing and repeating the following until transitioned into a one-handed operation or two-handed operation of a user: (a) if more than one controller connection is detected, transitioning into the two-handed operation; (b) if no controller connection is detected, requesting the user to connect the at least one controller; (c) if connection of only a first controller is detected, requesting the user to connect a second controller; (d) if connection of the second controller is not detected, transitioning into the one-handed operation, wherein the transition into the one-handed operation is made after determining and deciding to continue with only the first controller.

In one implementation, the at least one controller comprises at least one of: a single controller; a first paired controller including a pair of left and right controllers; a second paired controller including a left controller only; and a third paired controller including a right controller only. In one implementation, the single controller includes a pair of handles for the two-handed operation. In one implementation, the first controller is one of the left or right controller of the first, second, or third paired controller. In one implementation, the second controller is the other of the left or right controller of the first, second, or third paired controller. In one implementation, the first paired controller includes all controls of the single controller distributed on the left and right controllers. In one implementation, the decision to continue with only the first controller is made after inquiring whether the user desires to continue with only the first controller. In one implementation, the decision to continue with only the first controller is made after reviewing one of the status of the game system or non-game applications. In one implementation, the game system comprises at least one of virtual reality and augmented reality interactive game or non-game applications.

FIG. 2B is a flow diagram of a process 250 for managing controller connection in accordance with another implementation of the present disclosure. In one implementation, the process 250 identifies a controller type which the user wishes to use based on identification information received from the controller requesting the connection and determines the use mode. In one implementation, the process 250 compares a current mode or controller connection status with the specification of an application program (e.g., a game) and displays a notification (e.g., a notification that some operations are restricted or unsupported using the current controller) to the user. Further, the notification may include guide information displayed on the screen to change the connection of the controller.

In the illustrated implementation of FIG. 2B, a status check is made, at step 260, to determine whether at least one controller is connected. If no controller connection is detected, at step 260, the process 250 continues to perform the status check, at step 260. Otherwise, if at least one controller is detected, at step 260, a check is made, at step 270, to determine a type of connected controller. If a first type of controller (e.g., a single controller) is detected, at step 270, the process 250 continues with the first type of controller, at step 272. Otherwise, if a second type of controller (e.g., a paired controller) is detected, at step 270, a check is made, at step 280, to determine which controllers of the second type of controller are connected. If it is determined, at step 280, that both left and right controllers of the second type are connected, the process 250 continues with both left and right controllers of the second type. Otherwise, if it is determined, at step 280, that only one of the left and right controllers of the second type are connected, an inquiry is made, at step 290, whether the user wishes to continue with only one of the controllers of the second type. The process 250 continues with only one controller, at step 292, if the user wishes to continue with only one of the controllers of the second type. Otherwise, the process 250 repeats the check at step 280.

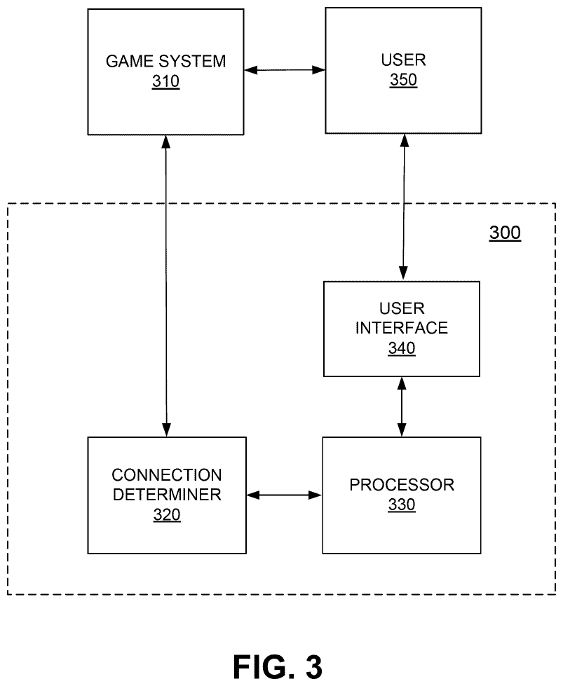

FIG. 3 is a block diagram of a controller management system 300 for managing controller connection in accordance with one implementation of the present disclosure. In the illustrated implementation of FIG. 3, the system 300 includes a connection determiner 320 coupled to a game system 310, a processor 330, and a user interface 340 coupled to the processor 330. In one implementation, the blocks 320, 330, 340 of the system 300 are configured entirely with hardware including one or more digital signal processors (DSPs), general purpose microprocessors, application specific integrated circuits (ASICs), field programmable logic arrays (FPGAs), or other equivalent integrated or discrete logic circuitry. In one implementation, the system 300 manages connections of controller configurations including at least one of: a single controller; a paired controller having a pair of left and right controllers; a paired controller including a left controller only; and a paired controller including a right controller only.

In the illustrated implementation of FIG. 3, the connection determiner 320 determines whether at least one controller is connected to the game system 310. If the connection determiner 320 detects no controller connection, the determiner 320 directs the processor 330 to request the user 350 through the user interface 340 to connect the controller to the game system 310. Otherwise, if the connection determiner 320 detects at least one connection, the connection determiner 320 determines whether only one controller is connected. The one connected controller may be either a right or left controller.

If the connection determiner 320 determines that there is more than one controller connected to the game system 310, the determiner 320 directs the processor 330 to transition into a two-handed operation. In one implementation, the two-handed operation may include maintaining all of the button assignments for the user to use a single controller or both right and left controllers of the paired controller.

Otherwise, if the connection determiner 320 detects only one controller connected, the determiner 320 directs the processor 330 to request the user through the user interface 340 to connect the second controller to the game system 310. The connection determiner 320 then determines whether the second controller has now been connected, and if that is the case, the determiner 320 directs the processor 330 to transition into a two-handed operation. Otherwise, if the connection determiner 320 does not detect a second controller connection, the determiner 320 determines whether the system 300 should continue with only one controller.

If the determiner 320 determines that the system 300 should continue with only one controller, the determiner 320 directs the processor 330 to transition into a one-handed operation. Otherwise, if the determiner 320 determines that the system 300 should not continue with only one controller because the system 300 does not allow the one-handed operation, the connection determiner 320 directs the processor 330 to request the user through the user interface 340 to connect the second controller to the game system 310. The processor 330 shall continue to request the user 350 to connect the second controller until the connection determiner 320 detects the connection of the second controller.

In a particular implementation, a system for managing controller connection is disclosed. The system includes: a connection determiner to determine whether at least one controller is connected to a game system; a user interface to enable a user to input and receive commands and requests; a processor to perform and repeat the following until transitioned into a one-handed operation or two-handed operation of the user: (a) if more than one controller connection is detected, transitioning into the two-handed operation of the user; (b) if no controller connection is detected, sending a command to the user interface to connect the at least one controller; (c) if connection of only a first controller is detected, sending a command to the user interface to connect a second controller; (d) if connection of the second controller is not detected, transitioning into the one-handed operation of the user, wherein the transition into the one-handed operation is made after determining and deciding to continue with only the first controller.

In one implementation, the at least one controller comprises at least one of: a single controller; a first paired controller including a pair of left and right controllers; a second paired controller including a left controller only; and a third paired controller including a right controller only. In one implementation, the single controller includes a pair of handles for the two-handed operation. In one implementation, the first controller is one of the left or right controller of the first, second, or third paired controller. In one implementation, the second controller is the other of the left or right controller of the first, second, or third paired controller. In one implementation, the decision to continue with only the first controller is made after sending a command to the user interface to inquire whether the user desires to continue with only the first controller. In one implementation, the decision to continue with only the first controller is made after reviewing one of the status of the game system or non-game applications. In one implementation, the game system comprises at least one of virtual reality and augmented reality interactive game or non-game applications.

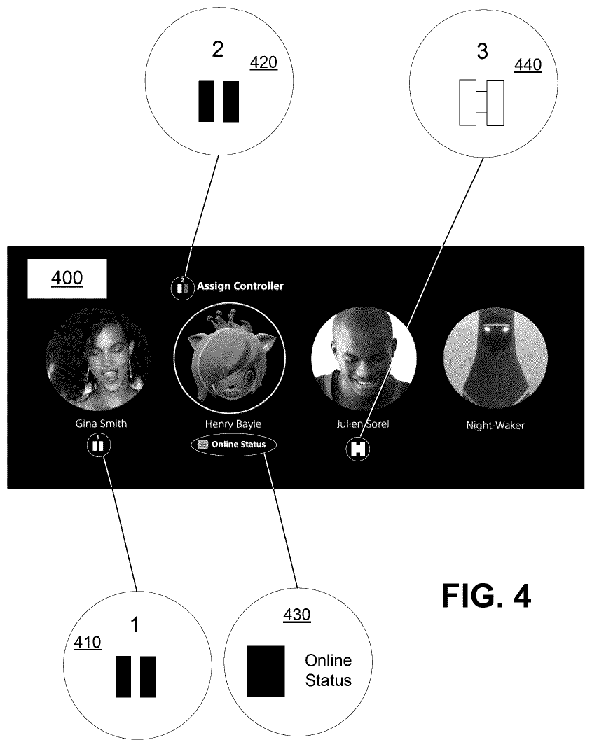

FIG. 4 is a list 400 of user icons who are playing or experiencing interactive games or application programs in accordance with one implementation of the present disclosure. In the illustrated implementation of FIG. 4, the list 400 shows the users identified with icons showing the identifiers of other users. For example, the identifiers include photographs or names of the other users. In one implementation, the identifiers include indication(s) of types of controllers (e.g., user 1 identifier 410 shows an indication of using two controllers, while user 2 identifier 420 shows an indication of using left controller) connected and used by the other users. In another example, the user 3 identifier 440 shows an indication of using a single controller similar to the controller 100 of FIG. 1A. In another implementation, the identifiers include strings explaining online status and actions (e.g., user 2 identifier 430 also shows the online status of user 2) of the other users.

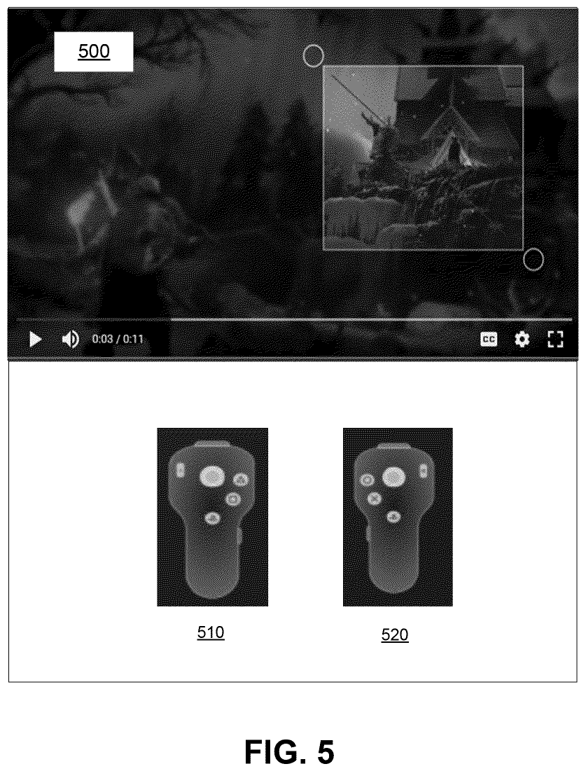

FIG. 5 is a screen shot 500 of a gestural operation performed by a user in an interactive game in accordance with one implementation of the present disclosure. In the illustrated implementation of FIG. 5, the user performs the operation using the paired controller including the left controller 510 and the right controller 520. The screen shot 500 shows the user clipping a virtual image, for example, to share the image through social media platforms. In one implementation, buttons are assigned to each of the left controller 510 and the right controller 520 for selection including click and hold movement to define the image to clip.

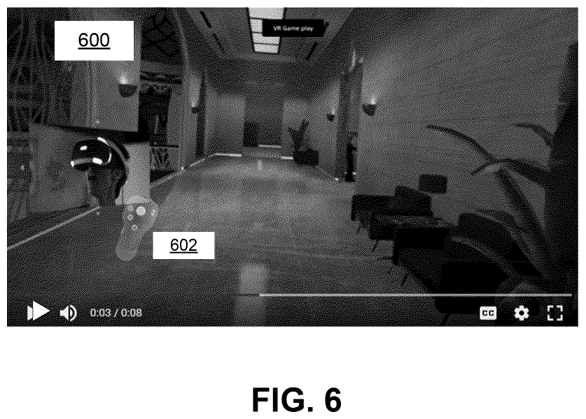

FIG. 6 is a screen shot 600 of another gestural operation performed by a user in an interactive game in accordance with another implementation of the present disclosure. In the illustrated implementation of FIG. 6, the screen shot 600 shows superimposing of an image capture of the gameplay of the user by a camera of a game system. In one implementation, the user may reposition or resize a viewing window of the image capture. A gestural operation may be used to resize the window or objects. In this screen shot, a silhouette 602 of the controller is shown to aid the user in performing the gestural operations.

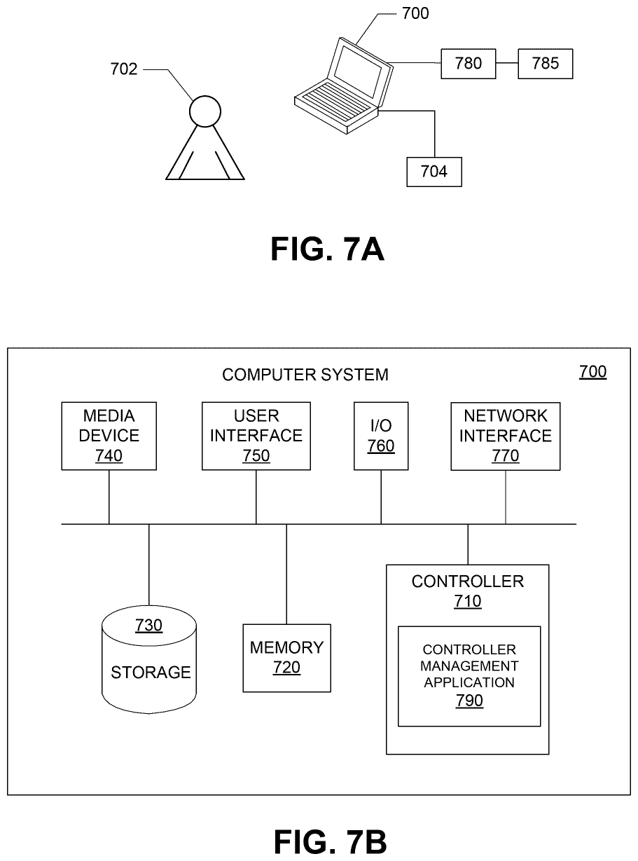

FIG. 7A is a representation of a computer system 700 and a user 702 in accordance with an implementation of the present disclosure. The user 702 uses the computer system 700 to implement a controller management application 790 for managing controller connection with respect to the processes 200 and 250 of FIGS. 2A and 2B, and the system 300 of FIG. 3.

The computer system 700 stores and executes the controller management application 790 of FIG. 7B. In addition, the computer system 700 may be in communication with a software program 704. Software program 704 may include the software code for the controller management application 790. Software program 704 may be loaded on an external medium such as a CD, DVD, or a storage drive, as will be explained further below.

Furthermore, computer system 700 may be connected to a network 780. The network 780 can be connected in various different architectures, for example, client-server architecture, a Peer-to-Peer network architecture, or other type of architectures. For example, network 780 can be in communication with a server 785 that coordinates engines and data used within the controller management application 790. Also, the network can be different types of networks. For example, the network 780 can be the Internet, a Local Area Network or any variations of Local Area Network, a Wide Area Network, a Metropolitan Area Network, an Intranet or Extranet, or a wireless network.

FIG. 7B is a functional block diagram illustrating the computer system 700 hosting the controller management application 790 in accordance with an implementation of the present disclosure. A controller 710 is a programmable processor and controls the operation of the computer system 700 and its components. The controller 710 loads instructions (e.g., in the form of a computer program) from the memory 720 or an embedded controller memory (not shown) and executes these instructions to control the system. In its execution, the controller 710 provides the controller management application 790 with a software system. Alternatively, this service can be implemented as separate hardware components in the controller 710 or the computer system 700.

Memory 720 stores data temporarily for use by the other components of the computer system 700. In one implementation, memory 720 is implemented as RAM. In another implementation, memory 720 also includes long-term or permanent memory, such as flash memory and/or ROM.

Storage 730 stores data either temporarily or for long periods of time for use by the other components of the computer system 700. For example, storage 730 stores data used by the controller management application 790. In one implementation, storage 730 is a hard disk drive.

The media device 740 receives removable media and reads and/or writes data to the inserted media. In one example, the media device 740 is an optical disc drive.

The user interface 750 includes components for accepting user input from the user of the computer system 700 and presenting information to the user 702. In one implementation, the user interface 750 includes a keyboard, a mouse, audio speakers, and a display. The controller 710 uses input from the user 702 to adjust the operation of the computer system 700.

The I/O interface 760 includes one or more I/O ports to connect to corresponding I/O devices, such as external storage or supplemental devices (e.g., a printer or a PDA). In one implementation, the ports of the I/O interface 760 include ports such as: USB ports, PCMCIA ports, serial ports, and/or parallel ports. In another implementation, the I/O interface 760 includes a wireless interface for communication with external devices wirelessly. In a further implementation, the I/O interface 760 includes Bluetooth® Tooth wireless connection providing wireless connection access to the computer system 700 for game controller(s).

The network interface 770 includes a wired and/or wireless network connection, such as an RJ-45 or “Wi-Fi” interface (including, but not limited to 802.11) supporting an Ethernet connection.

The computer system 700 includes additional hardware and software typical of computer systems (e.g., power, cooling, operating system), though these components are not specifically shown in FIG. 7B for simplicity. In other implementations, different configurations of the computer system can be used (e.g., different bus or storage configurations or a multi-processor configuration).

In a particular implementation, a non-transitory computer-readable storage medium storing a computer program to manage controller connection is disclosed. The computer program includes executable instructions that cause a computer to: determine whether at least one controller is connected to a game system, and perform and repeat the following until transitioned into a one-handed operation or two-handed operation of a user: (a) if more than one controller connection is detected, transitioning into the two-handed operation; (b) if no controller connection is detected, requesting the user to connect the at least one controller; (c) if connection of only a first controller is detected, requesting the user to connect a second controller; (d) if connection of the second controller is not detected, transitioning into the one-handed operation, wherein the transition into the one-handed operation is made after determining and deciding to continue with only the first controller.

In one implementation, the decision to continue with only the first controller comprises executable instructions that cause a computer to inquire whether the user desires to continue with only the first controller. In one implementation, the decision to continue with only the first controller comprises executable instructions that cause a computer to review one of the status of the game system or non-game applications. In one implementation, the game system comprises at least one of virtual reality and augmented reality interactive game or non-game applications.

The description herein of the disclosed implementations is provided to enable any person skilled in the art to make or use the present disclosure. Numerous modifications to these implementations would be readily apparent to those skilled in the art, and the principles defined herein can be applied to other implementations without departing from the spirit or scope of the present disclosure. Thus, the present disclosure is not intended to be limited to the implementations shown herein but is to be accorded the widest scope consistent with the principal and novel features disclosed herein. Accordingly, additional variations and implementations are also possible.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for managing controller connection, the method comprising:
determining whether at least one controller is connected to a game system, and performing and repeating the following until transitioned into a one-handed operation or two-handed operation of a user:
a) if more than one controller connection is detected, transitioning into the two-handed operation;
b) if no controller connection is detected, requesting the user to connect the at least one controller;
c) if connection of only a first controller is detected, requesting the user to connect a second controller;
d) if connection of the second controller is not detected, transitioning into the one-handed operation, wherein the transition into the one-handed operation is made after determining and deciding to continue with only the first controller.

2. The method of claim 1, wherein the at least one controller comprises at least one of:
a single controller;
a first paired controller including a pair of left and right controllers;
a second paired controller including a left controller only; and
a third paired controller including a right controller only.

3. The method of claim 2, wherein the single controller includes a pair of handles for the two-handed operation.

4. The method of claim 2, wherein the first controller is one of the left or right controller of the first, second, or third paired controller.

5. The method of claim 4, wherein the second controller is the other of the left or right controller of the first, second, or third paired controller.

6. The method of claim 2, wherein the first paired controller includes all controls of the single controller distributed on the left and right controllers.

7. The method of claim 1, wherein the decision to continue with only the first controller is made after inquiring whether the user desires to continue with only the first controller.

8. The method of claim 1, wherein the decision to continue with only the first controller is made after reviewing one of the status of the game system or non-game applications.

9. The method of claim 1, wherein the game system comprises at least one of virtual reality and augmented reality interactive game or non-game applications.

10. A system for managing controller connection, the system comprising:
a connection determiner to determine whether at least one controller is connected to a game system;
a user interface to enable a user to input and receive commands and requests;
a processor to perform and repeat the following until transitioned into a one-handed operation or two-handed operation of the user:
a) if more than one controller connection is detected, transitioning into the two-handed operation of the user;
b) if no controller connection is detected, sending a command to the user interface to connect the at least one controller;
c) if connection of only a first controller is detected, sending a command to the user interface to connect a second controller;
d) if connection of the second controller is not detected, transitioning into the one-handed operation of the user, wherein the transition into the one-handed operation is made after determining and deciding to continue with only the first controller.

11. The system of claim 10, wherein the at least one controller comprises at least one of:
a single controller;
a first paired controller including a pair of left and right controllers;
a second paired controller including a left controller only; and
a third paired controller including a right controller only.

12. The system of claim 11, wherein the single controller includes a pair of handles for the two-handed operation.

13. The system of claim 10, wherein the first controller is one of the left or right controller of the first, second, or third paired controller.

14. The system of claim 13, wherein the second controller is the other of the left or right controller of the first, second, or third paired controller.

15. The system of claim 10, wherein the decision to continue with only the first controller is made after sending a command to the user interface to inquire whether the user desires to continue with only the first controller.

16. The system of claim 10, wherein the decision to continue with only the first controller is made after reviewing one of the status of the game system or non-game applications.

17. The system of claim 10, wherein the game system comprises at least one of virtual reality and augmented reality interactive game or non-game applications.

18. A non-transitory computer-readable storage medium storing a computer program to manage controller connection, the computer program comprising executable instructions that cause a computer to:
determine whether at least one controller is connected to a game system, and perform and repeat the following until transitioned into a one-handed operation or two-handed operation of a user:
a) if more than one controller connection is detected, transitioning into the two-handed operation;
b) if no controller connection is detected, requesting the user to connect the at least one controller;
c) if connection of only a first controller is detected, requesting the user to connect a second controller;
d) if connection of the second controller is not detected, transitioning into the one-handed operation, wherein the transition into the one-handed operation is made after determining and deciding to continue with only the first controller.

19. The non-transitory computer-readable storage medium of claim 18, wherein the decision to continue with only the first controller comprises executable instructions that cause a computer to
inquire whether the user desires to continue with only the first controller.

20. The non-transitory computer-readable storage medium of claim 18, wherein the decision to continue with only the first controller comprises executable instructions that cause a computer to
review one of the status of the game system or non-game applications.

21. The non-transitory computer-readable storage medium of claim 18, wherein the game system comprises at least one of virtual reality and augmented reality interactive game or non-game applications.
